(19) United States
(12) Patent Application Publication
(10) Pub. No.: US 2026/0001014 A1
(43) Pub. Date: Jan. 1, 2026

(54) SYNTHETIC MONOFILAMENT OPEN-MESH FILTER FABRIC WITH ASYMMETRIC CONSTRUCTION FOR LIQUID/SOLID FILTRATION HAVING LOW LOSS OF LOAD AND FACILITATED REGENERATION CAPACITY

(71) Applicant: SAATI S.P.A., Appiano Gentile (IT)

(72) Inventors: Marco MIETTA, Appiano Gentile (IT); Lorenzo GELSO, Appiano Gentile (IT); Carmine LUCIGNANO, Appiano Gentile (IT); Roberto MOMENTE, Appiano Gentile (IT); Sergio PESENTI, Appiano Gentile (IT); Paolo CANONICO, Appiano Gentile (IT)

(21) Appl. No.: 19/114,811

(22) PCT Filed: Nov. 7, 2023
(86) PCT No.: PCT/IB2023/061230

§ 371 Date: Mar. 25, 2025

(30) Foreign Application Priority Data
Nov. 8, 2022 (IT) 102022000023049

(51) Int. Cl. B01D 39/08

(52) U.S. Cl. CPC B01D 39/083; B01D 2239/0613; B01D 2239/1216; B01D 2239/1233

(57) ABSTRACT

The invention discloses polypropylene monofilament filter cloth special for beer, which is characterized in that warp and weft yarns are 0.28 mm polypropylene monofilaments, the warp yarn density is 300/10 cm, and the weft yarn density is 140/10 cm; a two-up two-down twill plus one-up one-down plain double-weave weaving method is adopted for cloth cover weave innovation, the warp and weft woven double-fabric weave is combined with the filter cloth, and through double innovation of the silk thread type and the weaving method, the breaking strength of the filter cloth is improved, the service life is prolonged, the softness of the filter cloth is improved, the filter cloth is more attached to the surface of a filter plate, and the filter cloth is more attractive in appearance. The filtering efficiency is improved.

### BACKGROUND OF THE INVENTION

The present invention relates to an open-mesh filter fabric having an asymmetrical structure for technical or industrial use, usable in the production of filters for the removal, from liquids and in particular from water, of polluting particulate matter of various kinds.

Water is the most present chemical compound on earth and the major constituent of the human body. The uses of water are countless. Consider, for example, its uses in the home environment, in the industrial sector, in agriculture and more generally in the primary sector (agriculture, fishing, breeding, forestry, mining).

In the complex water cycle, water is subjected to multiple changes of state and to important displacements that cause contamination thereof (contact with other fluids, with inorganic or organic solid particulate, with minerals and microbiological one) which, in most cases, makes it unsuitable for specific uses within the sectors listed above.

Several applications, therefore, require various levels of water decontamination. Think for example to drinking water, to demineralized water, to water used in cooling circuits or to recirculation water used in closed circuits, such as for example in breeding farms or in swimming pools. Therefore, known the degree of purity required to the water for the specific use and known the initial level of contamination of water (waste waters, black waters, grey waters, white waters, rainwaters), it is necessary to provide adequate and very often complex processing systems.

Filtration is definitely the most used technique to remove the solid substances suspended in water. In its most general sense filtration involves the passage of a contaminated liquid or gas through a purifying medium, able to adequately remove the contaminating compound. There are multiple water filtration systems and very often they are used in combination to obtain an adequate quality.

Consider for example:
gravity separation for the coarse removal of the material in suspension by decanting;
filtration with granular media (e.g. sand filters), to which the dosing of chemical products with coagulating and flocculating power can be complemented;
physical filtration by barriers and without the use of chemicals;
membrane separation treatments.

Mechanical filtration allows the removal of particulate matter from 1 μm upwards, microfiltration concentrates in the range 0.1-1 μm, ultrafiltration in the range 0.01-0.1 μm, reverse osmosis and nanofiltration in the range 0.001-0.01 μm.

In the present invention we will focus on mechanical filtration (>1 μm), a filtration step almost always essential and present in almost all water decontamination processes. In particular think about the management of waste water, of drinking water and recirculation water, used in breeding farms as well as in aquaculture. With regard to the mechanical filtration, the most used processes are certainly:
drum filtration
disk filter
sand filtration
bag filtration
cartridge filtration

The different process types are chosen according to the required filtration level, according to the flows involved and the pressures at play, in order to have a higher filtration efficiency and suffer as little as possible of any problems of clogging. To this end it is customary to divide the process into at least two stages: separation of the coarse particulate by sedimentation, followed by finer filtration.

In drum filtration, the liquid to be filtered is passed through a rotating drum. The drum turns slowly (a few rounds per minute), the filter medium is held tight, to form the drum filter, by means of a metal frame or a frame made of a polymeric material. Depending on the type of frame, different processes can be used for the production of the filter. This ranges from simple bonding, to compression moulding or even to injection moulding.

During the rotational motion the filter takes the captured impurities out of the water, conveying the water thus filtered into a drainage channel. The filters, according to their application, can be properly sized in order to filter from 5 μm upwards, from 10 m³/h up to typical values in the order of 4500 m³/h. Typically during their usage the filters are cleaned with a counter flow of water and there is an automatic control of the head to ensure its consistency during the use.

In the disk filters water is conveyed inside a drum, inside which there are also filters, typically having a trapezoidal shape, joined to form a rotating disk inside the water. During this motion the filters are crossed by water, removing the contaminant particles. Even in this case, the filter medium is held tight, to form the drum filter, by means of a metal frame or a frame made of a polymeric material.

As far as the sand filters are concerned, there is a great variety of filter media, customized for different flow rates and to ensure different filtration efficiencies. Typically, they consist of a fabric or a non-woven fabric, filled with silica (typical granulometry from 0.5 to 1 mm) which indeed carries out the filtering action. In addition to the filter layer there is also a support layer made up of larger size particulate matter. The sand filters can be in both vertical and horizontal configuration. The sizing and the designing of sand filters depend on many parameters such as for example:
the filtration rate or the water flow rates involved; in aquaculture, for example, specific flows in the order of tens of m³/m²h are suggested;
the height of the filtering bed, which is essential to ensure the desired level of efficiency;
the characteristic size of the filter medium, which is equally important to ensure the desired level of efficiency but at the same time not to generate excessive pressure drops;
the arrangement of filtered water headers;
the washing system of the filter which, when clogged, generates excessive pressure drops.

The bag filters are particularly suitable for applications where there are large quantities of contaminants, large flow rates, relatively low pressure drops, when a rather economical and easy to use filter solution is required. In this case the fluid is circulated through filtering sleeves fitted on a frame. There is a wide variety of types of filtering sleeves and frames depending on the applications.

Cartridge filtration consists of circulating the fluid through a vessel containing the filter cartridge. It has typically a metallic and plastic frame which has the function of giving mechanical strength to the filter medium which, depending on the applications, can be made of fabric, non-woven fabric, wound thread, membranes made of a polymeric and/or metallic material. Fluid passes through the cartridge that retains the contaminant and, depending on the type of filter medium used, the cartridge can be detachable and cleanable or disposable.

At a purely conceptual and theoretical level all the mentioned processes are united by the same type of required performance, namely filtration efficiency on one hand and permeability to liquid on the other hand.

As far as the filtration efficiency is concerned, it is defined as the ratio of particulate matter stopped by the filter to the total number of incident particles on the filter medium. It is intuitive to understand that, defined a certain particle size, the demand is typically to have the maximum filtration efficiency. It is equally intuitive to understand that, in order to maximize the filtration efficiency, the typical characteristic size of the filter medium (pore or filter mesh size) must be smaller than the particulate matter to be blocked. In addition, the smaller the filtering mesh, the greater the filtration efficiency.

It should be noted that the above considerations are fully valid only for filter fabrics made from monofilament yarns. In particular the term “monofilament” or “monofilament yarn” means a monolithic yarn, that is not consisting of an interweaving of threads or strands of smaller size, but, on the contrary, a monolithic element having a constant circular section.

In this case the geometry of the filter fabric is perfectly defined and one can uniquely measure the distance between the next two threads of each mesh or pore, thus defining the value of the mesh opening or pore size which determines the size of the particulate matter that can be stopped by the filter mesh.

Vice versa, the other required performance concerns the flow of liquid that the filter medium manages to guarantee at the initial time and during usage. Even in this case it is intuitive to understand that, defined a maximum working pressure drop, the highest possible flows are sought. Vice versa, defined a working flow, media are sought which are able to minimize pressure drops that result in energy consumption at the pump or electromechanical system providing the fluid movement through the cartridge.

A further requirement stems from the will to maximize the service life of the filter before its clogging. Starting with a filter medium that, when new, offers a very reduced pressure drop (ΔP), means to guarantee a greater margin before the limit pressure at clogging is reached, and therefore a longer life for the filter element before its replacement or regeneration.

In case of regeneration, moreover, an open-mesh monofilament fabric would also favour the counter current washing, ensuring a high and free flow of the washing water. In addition, a monofilament yarn would minimize the risk of trapping contaminant particles inside the yarn itself permanently.

In summary, minimising pressure drop and/or optimising flows results in the use of particularly permeable filter media.

It is therefore clear that, in the case of choice of the filter medium made of monofilament fabric, the latter must necessarily have an “open-mesh” configuration, that is with suitably spaced threads or yarns and with a diameter such as to determine a plurality of visible mesh openings on the surface of the fabric in a plan view and that can be crossed by a flow of fluid with movement in the direction perpendicular to the plane of the fabric itself.

In these conditions the open-mesh monofilament fabric of the invention allows to define the values of:
“mesh opening” or “pore size”, measured as the distance between the threads in a plan view (see FIG. 3); and
“open area %”, computed as the ratio between the open mesh area, measured in plan (see FIG. 4a) and the total area of competence of the single mesh, measured with respect to the centreline of threads that define it (see FIG. 4).

It should be noted that the configuration of the open-mesh monofilament fabric suitable for the purposes of the invention is different from the closed-mesh one, because the latter has a linear density of the threads or mesh count (number of threads/cm) and a thread diameter, in one of the two directions of weft and warp, such as to reach the so-called “saturation”, wherein parallel threads touch each other, no longer forming any visible mesh in a plan view (Tressen, Reps, Dutch Weave, Double Dutch Weave fabrics). This involves obtaining a very small passage section, that allows the only crossing flows in the diagonal direction with respect to the fabric plane. This way particles of contaminant much smaller than the size of the thread are filtered, however with the generation of pressure drops considerably higher than those that are achieved with the use of the open-mesh monofilament fabric of the invention.

In fact, the well-known closed-mesh fabrics are normally used for the process filtration, in which preference is given to the high-pressure separation of large quantities of contaminants with medium-fine fineness (such as sludge), to the detriment of the pressure drops which, with these fabrics, reach very important values.

On the contrary, the filters of the invention, made with an open-mesh fabric, can be used in all applications of solid/liquid filtration, wherein it is necessary to maximize flows and minimize pressure drops.

The goal of minimizing pressure drops and/or optimizing flows therefore results in the use of particularly permeable filter media and can be achieved with the use of the open-mesh monofilament fabric suitable for the applications of the invention:
by using media with particularly large pores/mesh openings, which would however impair the filtration performance;
by maximizing the percentage of open area or volume of the medium, defined as % of open area and total area of the filter medium and open volume % on the total volume of the medium, keeping small size of pores in order to maximize the filtration efficiency.

From the above description it is evident that the two performances would require materials characterized by contrasting physical-geometric properties and therefore a phase of design and optimization is necessary in every single case. When reusable, and therefore washable, filters are concerned, in the range from 5 μm upward, and especially precision filters, the ideal solution in terms of filter media is represented by precision fabrics made of a synthetic and metallic monofilament. Filter medium weight plays an important role in many applications (see drum filters).

Therefore, in order to save energy, the reduction of masses makes the use of synthetic monofilaments preferable to the metal counterpart, while on the contrary using a multifilament yarn, that is consisting of several filaments twisted together, would not guarantee the achievement of a precise mesh opening having the desired size, which would affect the filtration efficiency.

All of the aforementioned requires that the fabric has a high open area, in order to minimize the resistance of the material to the passage of the liquid. In parallel, the same fabric must also ensure an adequate filtration efficiency and therefore have a suitably narrow mesh opening.

In conclusion, a reduction of the mesh opening size is needed while preserving the void/full ratio, that is the open area of the fabric. For the square mesh fabrics of the prior art, these two antithetical requirements are only partially met, as we will see now.

In order to reduce the mesh size there are two possible ways to go. The first one provides for the possibility of inserting an increasing number of threads of the fabric, the diameter being fixed. The second one provides, instead, for the use of the same number of threads, but with a higher thread diameter. It is evident that in both cases the void/full ratio decreases and the water passage performance would deteriorate. Therefore, in order to obtain a smaller size of the mesh while keeping the void/full ratio constant, it is intuitive to think that the only viable way consists in using an increasing number of threads but at the same time a smaller and smaller diameter of the threads. This third way, apparently ideal, however shows two limits:
a technological limit in the processing of the yarn, whereby below a specific diameter it is neither possible to extrude the monofilament nor even weave it,
a technological limit in the weaving process, whereby it is not possible to increase beyond a certain threshold the linear density of the threads per cm (mesh count/cm). In some cases, where the application imposes high protection requirements and a mesh having particularly small size is needed, the use of a lower diameter of the thread might impose a structure having a number of threads impossible to achieve. This is true in particular for the warp threads, that is those arranged according to the roll length of the produced material, where there are major critical issues. These are related to the need to pass all the warp threads through the openings of the weaving reed, whose thin blades impose limits on the spacing of threads. There are in addition mechanical limits, since the set of warp threads is very mechanically stressed due to the stresses imposed on the frame.

It is therefore clear that the mentioned traditional choice, namely that of decreasing the mesh size, necessarily involves the drawback of decreasing also the open area of the mesh itself, as there is no state-of-the-art solution to obtain both benefits simultaneously.

From all the above we deduce that the choice of the best square mesh fabric for water filtration of the prior art is always a compromise: very closed fabrics favour protection but are poorly performing from the energy point of view; more open fabrics offer instead an acceptable transparency to the passage of fluids (with minimum pressure drop) but show a too large mesh opening to effectively stop all particles of contaminant.

### SUMMARY OF THE INVENTION

The main object of the present invention is to provide an open-mesh synthetic monofilament fabric for use in liquid/solid filtration, and in particular water filtration, preferably for the production of drum filters or cartridge filters, which, unlike the prior art fabrics, has a better solid particle stopping capacity while guaranteeing the same liquid flow; or, alternatively, which shows a higher flow (that is, lower pressure drop) with equal ability of protection from particles compared to the prior art.

These and other objects are achieved with the fabric of claim 1. Some preferred embodiments of the invention result from the remaining claims.

In relation to of the prior art fabrics having comparable air flow and water passage characteristics, the fabric of the invention offers the advantage of presenting greater capacity of protection from contaminating particles. In addition, if compared with fabrics of the prior art and similar ones for what concerns the ability of protection against solid contaminants, the fabric of the invention has better water flow properties, which improve the energy yield of the filtration system, also ensuring a longer life of the filter element before clogging, as well as an easier possibility of regeneration through a counter current washing, where provided.

Of course, for each application of liquid/solid filtration it is possible to choose the structure of the new fabric most suitable for the purpose and to achieve a partial improvement, both in the first area (better protection) and in the second one (better flow), in any case to an overall extent greater than the prior art allows to achieve.

The fabric of the invention must be produced by weaving a synthetic monofilament yarn, more efficient than multifilament in terms of interception of contaminant particles. The material with which the starting monofilament is made can be a synthetic technopolymer belonging to the family consisting of polyesters, polyamides, polyaryletherketones, polyparaphenylene sulphide, polypropylenes, perfluorocarbons, polyurethanes, or polyvinyl chlorides. Alternatively, the material of the monofilament with which the fabric of the invention is made can be an artificial polymer belonging to the family consisting of cellulose or viscose.

The monofilament with which the fabric of the invention is made may have a diameter ranging from 10 μm up to 90 μm both in the warp direction and in the weft direction. The fabric of the invention may be produced with a textile structure requiring a number of threads per cm ranging from 23 up to 450.

The fabric may be manufactured with different open-mesh textile architectures, having the common feature of being asymmetrical in the two directions of weft and warp, with particular regard to the linear density of threads per centimetre and the diameter of the threads. Therefore, the numerical density of the weft threads will be different from the warp one and the weft threads will be different from the warp ones with regard to the diameter of the thread or the nature of the yarn.

As a result, it is possible to produce the fabric of the invention both with a square mesh, and with a rectangular mesh, depending on the choice of construction parameters of linear density, diameter of the threads and their mutual balancing in the asymmetrical configuration.

The mesh opening of the fabric of the invention may have values within a range from 5 to 150 μm, perfectly defined in the plan view of the open-mesh fabric.

Further examples given in the following Figures will better illustrate the textile structure of the invention.

### BRIEF DESCRIPTION OF THE DRAWINGS

These and other objects, advantages and characteristics result from the following description of some preferred embodiments of the fabric of the invention provided, by way of non-limiting examples, in the Figures of the attached drawings.

In them:

FIG. 1 shows an example of a filter cartridge on which the fabric of the invention may be used;

FIG. 2 shows a section of a classic disk filter on which the filter fabric of the invention may be used;

FIGS. 3, 4 and 4a illustrate the square mesh of a prior art fabric,

FIG. 4b illustrates the mesh of FIG. 3, when clogged by a contaminant particle;

FIGS. 5a, 6a represent a portion of an open-mesh monofilament filter fabric of the prior art, used as a basis for a comparison with the corresponding embodiments of the fabric of the invention;

FIGS. 5b, 6b represent two different embodiments of the open-mesh monofilament fabric of the invention, taken as an example and compared with the prior art fabrics of FIGS. 5a, 6a, respectively;

FIG. 7 illustrates a closed mesh monofilament fabric of the prior art, of “Dutch Weave” type;

FIGS. 8 and 9 report measurements of comparative data, relating to pressure drop and filtration efficiency, respectively, during an experimental test of filtration of the fabric of the invention, compared with a prior art fabric.

### DETAILED DESCRIPTION OF PREFERRED EMBODIMENTS

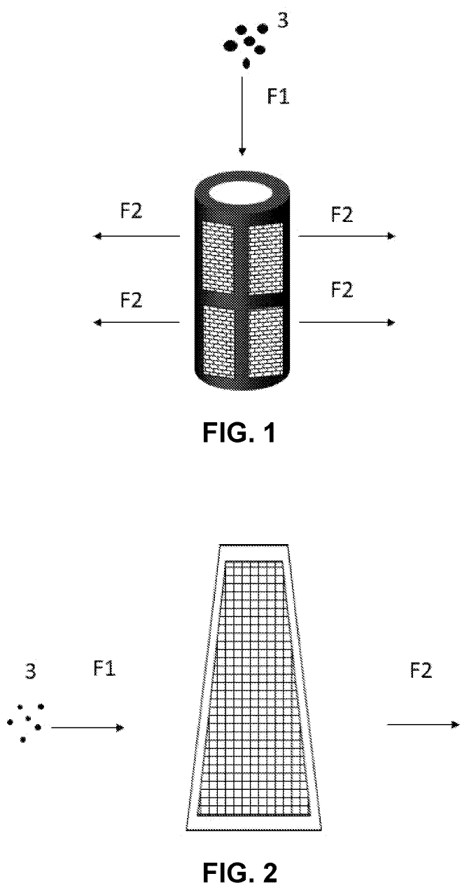

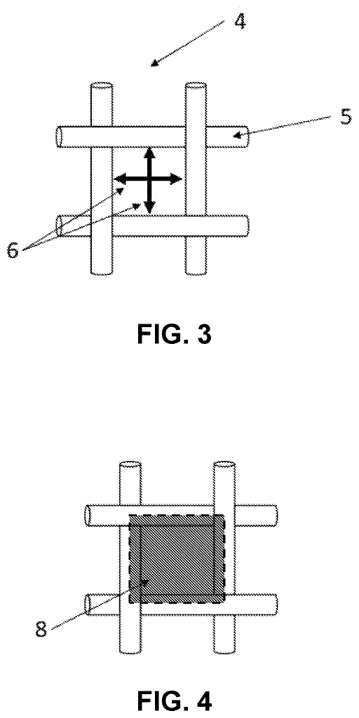

In the operation of the filter, as illustrated in FIGS. 1-2, a flow of water (arrow F1) is conveyed in the direction of the fabric 2, so as to obtain a downstream flow F2 of water, filtered out the contaminant 3 present in the upstream flow F1.

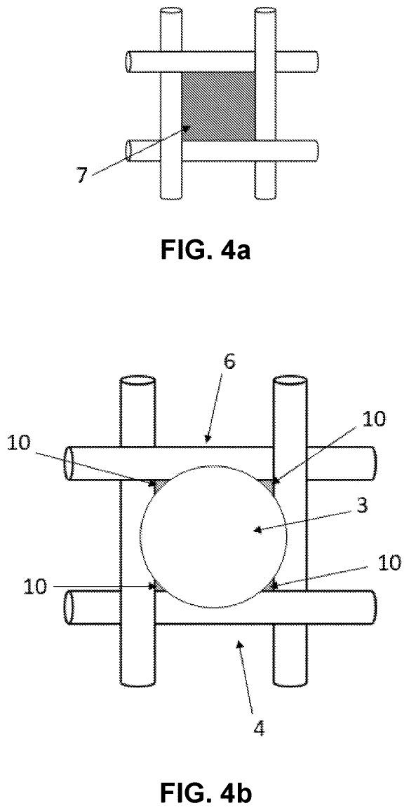

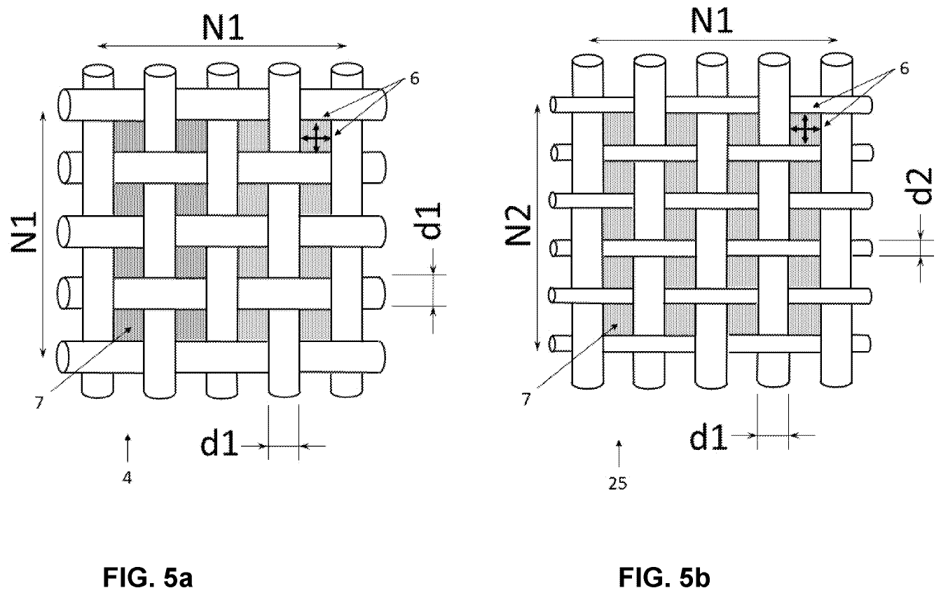

In the prior art illustrated in FIGS. 3 and 4, the mesh 4 of the fabric 2 is square and consists of threads 5 which form the respective sides 6 of the square mesh 4.

The open area of the mesh 4 itself of the prior art, illustrated in FIG. 4, is computed as a percentage ratio between the surface of the smaller square 7 (FIG. 4a), comprised between the profile or the inner edge of the threads 5 forming the sides 6 of the mesh 4 and the surface of the larger square 8 (FIG. 4), measured up to the centreline of the thickness of the threads 5 themselves.

When the mesh 4 of the prior art receives, from the flow F1 of water to be filtered, a particle of solid contaminant 3 having a diameter comparable with the length of the side 6 of the square mesh itself, the opening of the latter is clogged, leaving free for the passage of the flow of water only small portions 10 of the surface of the smaller square 7 of the mesh 4 (FIG. 4b).

As a consequence of the described phenomenon, an increase in the fluid pressure might occur in the part upstream the fabric 2 (arrow F1 in FIG. 2), capable of deforming the particle 3 of contaminant, until it passes through the mesh 4. In this way the filtration efficiency of the fabric is reduced in relation to the filter design value.

In addition, the described clogging of the square mesh 4 of the prior art increases pressure drops on the filter fabric, resulting in an increased energy demand to maintain the same flow rate of water to be filtered.

In order to overcome these drawbacks, the fabric of the invention is proposed, featuring a textile structure characterized by a different number of threads per cm in the two directions of weft and warp and by the weft threads different from the warp threads in diameter and possibly nature.

In particular, a ratio between the numerical densities of the threads in the warp direction and in the weft direction between 0.4:1 and 2.5:1, and a ratio between the diameter of the warp threads and the diameter of the weft threads between 0.5:1 and 2:1 is considered.

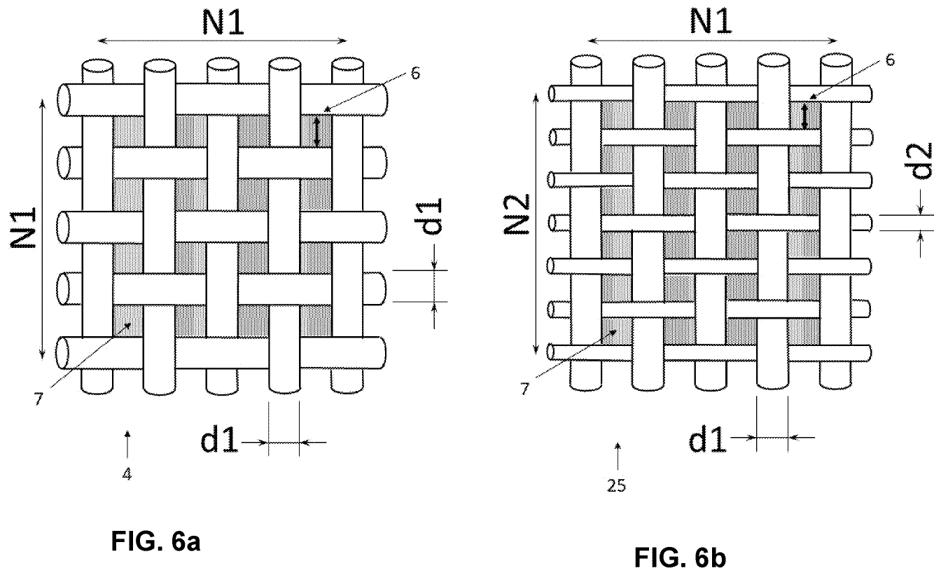

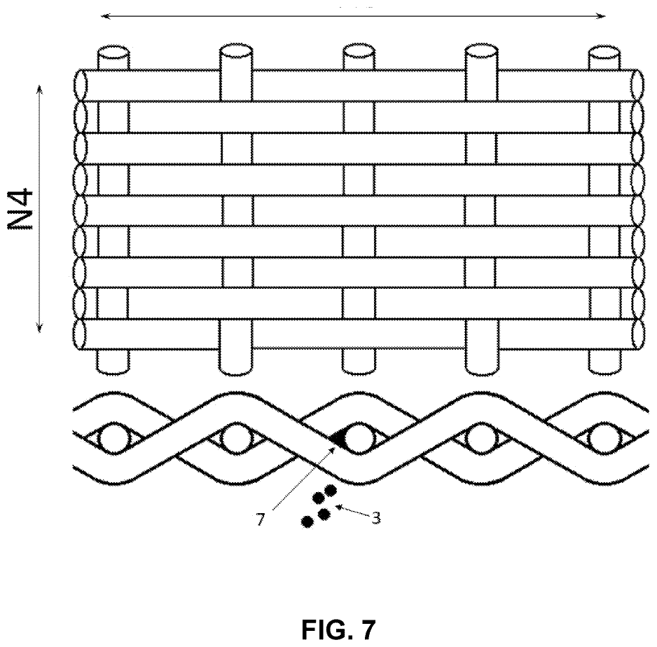

FIGS. 5b, 6b exemplify two possible and different embodiments of the fabric of the invention, compared with a corresponding fabric of the prior art to demonstrate the actual performance benefits of the invention itself.

In all the examples herein reported the fabric of the invention consists of synthetic monofilaments, offering optimal performance at the level of precision of the mesh opening and surface finishing, which prevents the contaminant from being trapped inside the yarn itself. The polymeric nature of the fabric also guarantees further advantages in terms of lightness and at the environmental level (recyclability).

Some embodiments of the solution of the present invention are now described in detail, compared with the equivalent textile structures of the prior art.

### FIGS. 5a /5b

FIG. 5a illustrates a portion of the prior art fabric 4, characterized by the same density of threads per cm (N1), both for the warp threads (vertical threads in the Figure) and for the weft threads (horizontal threads in the Figure). The prior art fabric has moreover the same thread diameter (d1) both for warp and weft threads. Accordingly, the open mesh 7 of FIG. 5a will be square shaped and will be characterized by identical size of the opening 6 of the mesh 7 in the two directions of weft and warp.

In FIG. 5b, a possible embodiment of the fabric 25 of the invention is now proposed, wherein both the densities of threads per unit of width in the two directions, and the respective diameters of the threads differ from each other. In this particular case:
The number of the warp threads per cm (N1, vertical threads in FIG. 5b) remains identical to that of the prior art fabric of FIG. 5a.
The number of the weft threads per cm (N2, horizontal threads in FIG. 5b) is instead higher than that of weft and warp threads and therefore also higher than the number of threads per cm of the prior art fabric (N1 for both directions, FIG. 5a). Note that this choice is typically possible in a normal process of weaving, as the density per cm of warp threads is conditioned by the presence of the weaving reed, while such constraint does not exist for the weft threads, which can therefore be thicker. The asymmetrical configuration is therefore possible and, as will be seen later, advantageous.
The diameter of the warp threads of the invention (d1, vertical threads in FIG. 5b) remains identical to that of the prior art fabric of FIG. 5a.
The diameter of the weft threads of the invention (d2, horizontal threads in FIG. 5b) is instead lower than that of weft and warp threads and therefore also than the diameter of threads of the prior art fabric (d1 for both directions, FIG. 5a). Note that this choice is typically possible in a normal process of weaving, as the weft threads are less stressed and smaller diameters can be used without compromising the quality of the fabric. The asymmetrical configuration is therefore possible and, as will be seen later, advantageous.

In addition, for the present example a number of weft threads per cm (N2) is selected such that, combined with the value of the diameter of the weft thread d2, it determines meshes 7 having perfectly square shape, with identical mesh openings 6 in the two directions, just like the prior art fabric 4 (FIG. 5a). In this way, the single mesh 7 intended to stop the contaminant particles will be identical to the prior art one, determining the same filtration efficiency for the two fabrics. At the same time, the fabric 25 of the invention will result in an improvement regarding the reduction of the pressure drop through the filter and with regard to the prolongation of service life before clogging and the subsequent possibilities of regeneration with counter current washing. All the above is achieved thanks to the greater open area of the fabric 25 of the invention (FIG. 5b) compared to the equivalent open area of the prior art fabric 4 (FIG. 5a).

In order to prove this, the sum of the open surfaces at the meshes 7 must be taken into account in both cases, compared to the relative reference area, which in this case is the portion of fabric depicted in FIGS. 5a and 5b, respectively. It can be seen that the prior art fabric (FIG. 5a) has 4×4=16 open square meshes in the area under consideration. The fabric of the invention (FIG. 5b) in an equivalent reference area has 4×5=20 open square meshes instead. Since the mesh openings are identical in both cases for the above choices, it turns out that the open area of the invention will be equal to 5/4 of the prior art one, with evident advantages in terms of lower pressure drop, and without any drawback in terms of filtration, because of the identical value of the mesh opening.

In addition, considering the greater number of square meshes per unit of surface that the new fabric presents, it must be considered that for occluding them all a greater number of contaminant particles than in the prior art will be needed, with consequent prolongation of the service life of the filter before clogging, and often also with improved possibility of counter current washing for the regeneration of the filter fabric.

In this first example, the invention therefore is a substantial improvement over the prior art, despite both fabrics having the same square-shape meshes with equal opening.

### FIGS. 6a /6b

As for the previous FIG. 5a, FIG. 6a also illustrates a portion of the prior art fabric 4 having the same density of threads per cm (N1) both for the warp threads (vertical in the Figure) and for the weft threads (horizontal in the Figure). The prior art fabric 4 has moreover the same thread diameter (d1) both for the warp and weft. The mesh 7 will have a square shape, with identical size of the mesh opening 6 in weft and warp (FIG. 6a).

As for the previous example, a second possible embodiment of the fabric 25 of the invention is now proposed (FIG. 6b), wherein both the densities of threads per cm and the respective diameters of threads differ in the two directions. Similar to the previous case, it turns out that:
The number of the warp threads per cm (N1, vertical threads in FIG. 6b) is identical to the prior art one in FIG. 6a.
The number of the weft threads per cm of the invention (N2, horizontal threads in FIG. 6b) is higher than both the number of the weft threads of the invention itself (N2, FIG. 5b) and the number of threads per cm for the prior art (N1 for both directions, FIG. 6a). As for the previous case, the compatibility of this choice with the weaving process is confirmed, as the density of the weft threads per cm is not conditioned by the presence of the weaving reed, which is binding for the warp threads only. The greater thickening of the weft threads is thus possible as well as beneficial.
The diameter of the warp threads of the invention (d1, vertical threads in FIG. 6b) is identical to the prior art one in FIG. 6a.
The diameter of the weft threads of the invention (d2, horizontal threads in FIG. 6b) is instead lower than the diameter of threads of the prior art fabric (d1 for both directions, FIG. 5a). This choice is also compatible with a normal process of weaving, since the weft threads are less stressed than the warp ones and it is possible to use smaller thread diameters for the weft. The asymmetrical configuration is therefore possible.

For this specific example a number of the weft threads per cm (N2) higher than the previous case of FIG. 5b is selected: in the present structure the weft threads are thicker and determine a reduction in the value of the mesh opening (which in this case is symmetrical in the two directions and therefore square shaped), in the warp direction (vertical, in FIG. 6b) compared to the corresponding opening of the prior art (vertical, in FIG. 6a). This will lead to an improvement in the filtration efficiency, resulting in the ability of the filter to stop smaller particles, especially if having a pseudo-spherical shape.

Note however that this improvement is not achieved at the expense of the ease of passage of the fluid (pressure drop, service life of the filter, washing/regeneration capability) compared to the prior art. In fact, taking into account that the previous configuration of the invention (FIG. 5a) was an improvement with respect to the open area compared to the prior art, it is possible to give up part of such improvement (but without ever falling below the value of the open area of the prior art) for converting it into an improvement in terms of filtering efficiency. With reference to FIG. 6b, note indeed that the displayed meshes have now become 4×6=24, many more even though of slightly smaller sizes compared to the fabric of the prior art. With an appropriate choice of density N2, it is then possible to make also this construction solution of the invention advantageous compared to the prior art, even with regard to the open area.

In conclusion, the embodiment of the invention herein described turns out to be an improvement over the prior art certainly in terms of filtration efficiency, with the possibility of maintaining also an advantage in terms of open area and low pressure drop.

The synthetic monofilament fabrics of the invention have an asymmetrical structure concerning the number of threads per cm and the diameter of the thread for the two directions of weft or warp.

The example of FIG. 5b ensures a clear increase in the value of the open area compared to the prior art fabric, which increase is useful to improve the resistance to the liquid flow and to clogging, the service life of the filter and, in several applications, also the possibility of regeneration and counter current washing.

The example described in FIG. 6b shows instead the capability of the invention of being an improvement with regard to a lower mesh opening, which entails better filtration efficiency compared to the prior art, while retaining a value of the open area equal to or even slightly better than the prior art, which therefore does not compromise fluid dynamics and does not introduce a higher pressure drop compared to the prior art (and in some cases could even improve this feature).

The synthetic monofilament structure is moreover ideal for minimizing weights and preventing contaminant particles from being trapped inside the yarn, which is a critical aspect in the case of a multifilament yarn consisting of several filaments instead. Finally, the smooth surface of the monofilament minimizes the possibility of adhesion of contaminant particles and promotes their slipping and removal during the counter current washing for the regeneration of the filter.

In order to maximize the above benefits, the synthetic monofilament fabric with an asymmetric structure of the invention must feature a ratio between the numerical densities of threads in the warp direction and in the weft direction ranging between 0.4:1 and 2.5:1, and a ratio between the diameter of the warp threads and the weft threads one ranging between 0.5:1 and 2:1.

In the filter fabric of the invention, yarns of various kinds or different sizes may be provided in combination either in the same direction or in the two different directions of weft and warp.

As previously explained, the object of the invention may be classified as an “open-mesh fabric” and thus differs substantially from closed-mesh and asymmetrical textile configurations of the prior art, such as the so-called “Tressen”, “Reps”, or “Dutch weave”, wherein the ratio between linear densities of threads per centimetre in the two directions is equal to 4:1 or higher, while it is at most equal to 2.5:1 for the present invention. The present invention is in fact aimed at maximizing the crossing section for a flow of liquid that crosses orthogonally the filter, minimizing the pressure drop thereof; on the contrary, for the above asymmetrical fabrics there is only the need to minimize the opening of the pore through which the fluid passes, specifically for the filtration applications wherein the pressure drop through the filter is not an issue. Therefore, in the asymmetrical fabrics of the prior art defined as “Tressen”, “Reps”, or “Dutch weave”, the threads of one of the two directions are brought to be adjacent to each other, reaching the so-called “saturation”, leaving only minimal openings for passage, suitable to ensure an advanced filtration while generating pressure drops significantly higher than the fabric of the present invention.

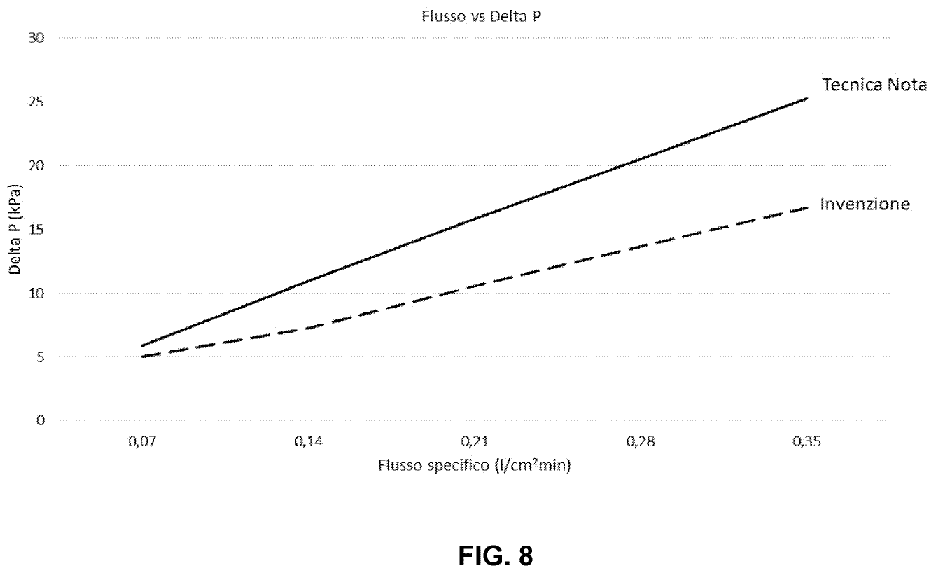

By way of example only, FIG. 7 shows a typical “Dutch weave” structure of the prior art, wherein the density of wefts (N4) is at least four times the warp density (N3) and reaches saturation, bringing the weft threads into contact with each other.

In particular, “saturation” of the fabric in the weft or warp direction is defined as the ratio between the product of linear density of threads per centimetre, multiplied by the diameter of the thread, in the corresponding weft or warp direction, and divided by the reference length used for the computation of the linear density of the threads.

For example, defined the density N1 of threads/cm and defined the diameter d1 of the corresponding threads, measured in μm, we have:

$$saturation = N 1 \times d 1 / 10000$$

normally expressed as a percentage.

For open-mesh filter fabrics the saturation is less than or equal to 70%. Thus, in no case the adjacent threads touch each other, and a crossing flow perpendicular to the plane of the fabric is always guaranteed.

On the contrary, closed-mesh filter fabrics are intentionally produced with a saturation next to 100%, bringing the adjacent threads into contact with each other. In this way the crossing section of the liquid phase is reduced to the small section 7 of FIG. 7, crossed by an oblique flow of water, which does not allow to define the open area.

As can be noted, the mesh opening is minimized and corresponds to the small area 7 identified in FIG. 7, capable of stopping small particles as shown herein in scale (3). Nevertheless, a fabric so closed and having such different purposes will produce pressure drops clearly higher than those obtainable by the fabric of the present invention, which is therefore not comparable at all with the asymmetric configuration of the prior art herein reported.

It follows from the present description that, by choosing an appropriately unbalanced and asymmetrical configuration for both the features of number of threads per cm and thread diameter for weft and warp, it is possible to obtain a larger open area than the fabric of the prior art and a smaller “effective” mesh opening (that is in the direction wherein it is minimum) compared to a symmetric fabric and even a higher open area.

As explained, the filtration efficiency is inversely proportional to the mesh size and directly proportional to the open area. It follows that the asymmetric textile structures of the present invention, aimed at maximizing the open area with equal mesh size, are able to optimize the filtration efficiency of the filter.

The tests of filtration efficiency and flow vs ΔP are carried out according to ISO19438/ISO16889 (filtration efficiency) and ISO 4548-1:1997 (flow) standards, respectively.

In the filtration efficiency test according to ISO19438/ISO16889 standards, the filter fabric is subjected to a controlled flow of contaminated liquid according to a type of contaminant and a specific concentration defined by the above standard. During the verification test a progressive clogging of the filter occurs that is monitored through the acquisition of the value of differential pressure (pressure drop) through the filter fabric. Similarly, the sensors of the test equipment acquire the size and the number of particles upstream and downstream of the filter. From these values it is possible to compute the filtration efficiency values as a function of the contaminant particle size (diagram of FIG. 9).

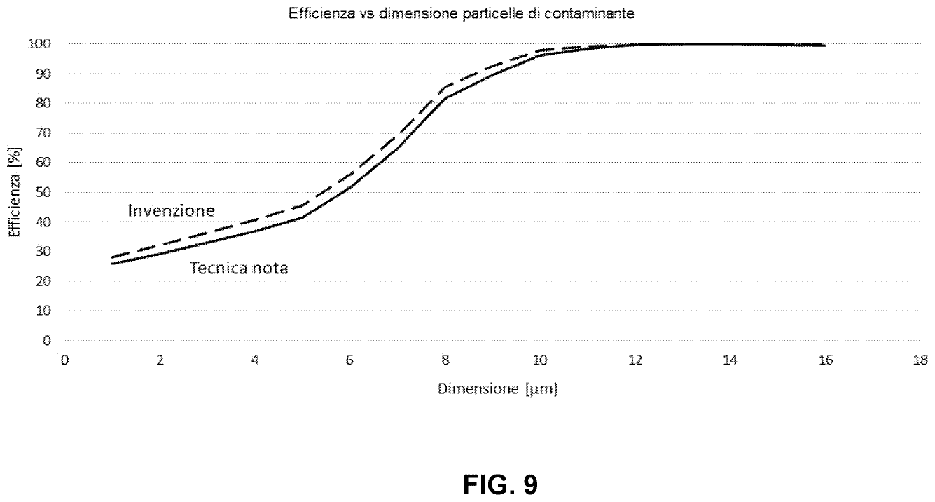

During the liquid permeability fluid dynamics test according to ISO 4548-1:1997 standard, the fabric sample is subjected to a gradually increasing flow of liquid. Depending on the value of the imposed flow, pressure sensors acquire the corresponding pressure drop value through the fabric, generating a graph ΔP vs. specific flow, as shown in FIG. 8.

The graphs reported in FIGS. 8 and 9 represent the results of these tests, carried out on a fabric 4 of the prior art having a symmetric structure and on a fabric 25 of the invention with asymmetric structure.

In particular:
the fabric 4 of the prior art has a symmetric structure with N1=215 threads/cm and a thread diameter d1=31 μm in both directions (both weft and warp); it has a mesh opening 6 equal to 12 μm and an open area of 7% (FIG. 6a);
the fabric 25 of the invention has an asymmetric structure with N1=200 threads/cm for the warp and N2=245 threads/cm for the weft, from which an effective mesh opening (in the direction wherein it is minimum) equal to 10 μm and an open area equal to 8.5% (FIG. 6b) derive.

From the performed tests, therefore, it results that:
using a test contaminant dust of the type Arizona Test Dust A3 (medium), the two fabrics have comparable filtration efficiency.
for the same guaranteed filtration efficiency and thus the same particle removal in the water filtration application, the flow ensured by the fabric with asymmetric structure, with equal pressure drops, is at least 20% higher.

1. Synthetic monofilament open-mesh filter fabric with asymmetric structure having spaced threads or yarns and with a diameter such as to determine a plurality of visible mesh openings on the surface of the fabric in a plan view and that can be crossed by a flow of fluid with movement in the direction perpendicular to the plane of the fabric itself, characterized in that it has a linear density/cm of the warp threads different from a linear density/cm of the weft threads, and characterized in that in which the diameter of the warp threads is different from the diameter of the weft threads, said diameter ranging from 10 μm to 90 μm both in the warp and weft directions, wherein the ratio between the linear densities/cm of the warp threads and of the weft threads in their respective directions is in the range between 0.4:1 and 2.5:1 and the ratio between the diameter of the warp threads and the diameter of the weft threads is in the range between 0.5:1 and 2:1.

2. (canceled)

3. (canceled)

4. Filter fabric according to claim 1, characterized in that the opening of each mesh is in the range between 5 and 150 μm.

5. Filter fabric according to claim 1, characterized in that said synthetic monofilament is a monofilament made of a synthetic technopolymer belonging to the family consisting of polyesters, polyamides, polyaryletherketones, polyparaphenylene sulfide, polypropylenes, perfluorocarbons, polyurethanes, or polyvinyl chlorides.

6. Filter fabric according to claim 1, characterized in that said synthetic monofilament is a monofilament made of an artificial polymer belonging to the family consisting of cellulose or viscose.

7. Filter fabric according to claim 1, characterized in that yarns of various kinds or different sizes are provided in combination either in the same direction or in the two different directions of weft and warp.

8. Filter fabric according to claim 1, for the use in cartridge filters, drum filters, or disk filters intended for water filtration, capable of ensuring an adequate water flow minimizing pressure drops, while optimizing the filtration efficiency and thus the removal of contaminant particles contained in the liquid, wherein said filter fabric is of the open-mesh type made of synthetic monofilament with asymmetric structure, having a linear density/cm of the warp threads different from the linear density/cm of the weft threads and wherein the diameter of the warp threads is different from the diameter of the weft threads.
